(19) United States
(12) Patent Application Publication
(10) Pub. No.: US 2005/0097004 A1
(43) Pub. Date: May 5, 2005

(54) Method of advertising and related products

(76) Inventor: Eduardo Masse Blume, Montreal (CA)

Correspondence Address: OGILVY RENAULT, 1981 MCGILL COLLEGE AVENUE, SUITE 1600, MONTREAL, QC, H3A2Y3, CA

(21) Appl. No.: 10/974,743

(22) Filed: Oct. 28, 2004

Related U.S. Application Data
(60) Provisional application No. 60/514,911, filed on Oct. 29, 2003.

(51) Int. Cl. G06F 17/60

(52) U.S. Cl. 705/26

(57) ABSTRACT

A method of advertising by a media enterprise and related products. The method comprises producing a label to be affixed to a product with the label containing paid advertisement of one or more advertising customers. The label is affixed to a product to be dispensed by distribution customers at no cost or minimal cost. A map of a geographical area is printed including a plurality of the distribution customers to identify them and their location in the geographical area. The products and the maps are delivered in predetermined quantities to the distribution customers where they are distributed to product end users.

### CROSS REFERENCE TO RELATED APPLICATION

This application claims priority on U.S. Provisional Application No. 60/514,911, filed on Oct. 29, 2003.

### TECHNICAL FIELD

The present invention relates to a method of advertising by a media enterprise and wherein the advertisement is affixed to a product(s) which is distributed to end users by product distributors at no cost or minimal cost.

### BACKGROUND ART

Various methods of advertisement are known and wherein an advertisement is secured to a product which is handed out to intended users. Such advertisement is usually of the type wherein the product is associated with a specific enterprise and handed out by that enterprise at the point of sale. For example, golf balls are handed out to customers with the golf ball having the name of an enterprise printed thereon. Keychain floats having the name of a marine accessories company are handed out by such company at the point of sale. There are numerous such advertising products. However, the dissemination of such is limited and does not entail mass distribution in a predetermined area and by several distribution customers.

### SUMMARY OF INVENTION

It is a feature of the present invention to provide a method of advertising by a media enterprise and comprising producing a label to be affixed to a product with the label containing paid advertisement of one or more advertising customers. The label is affixed to a product, which is dispensed by distribution customers at no cost or minimal cost to end users. A map of a geographical area is printed including a plurality of the distribution customers to identify them and their location in the geographical area. The products and the maps are delivered in predetermined quantities to the distribution customers where they are distributed to product end users.

### BRIEF DESCRIPTION OF DRAWINGS

A preferred embodiment of the present invention will now be described with reference to the accompanying drawings in which:

FIG. 1 is a flow diagram illustrating the method of advertising of the present invention;

FIG. 2 is an example of a product utilized in the method of advertising of FIG. 1; and

FIG. 3 is an extract from a contractual agreement with a distribution customer.

### DESCRIPTION OF PREFERRED EMBODIMENTS

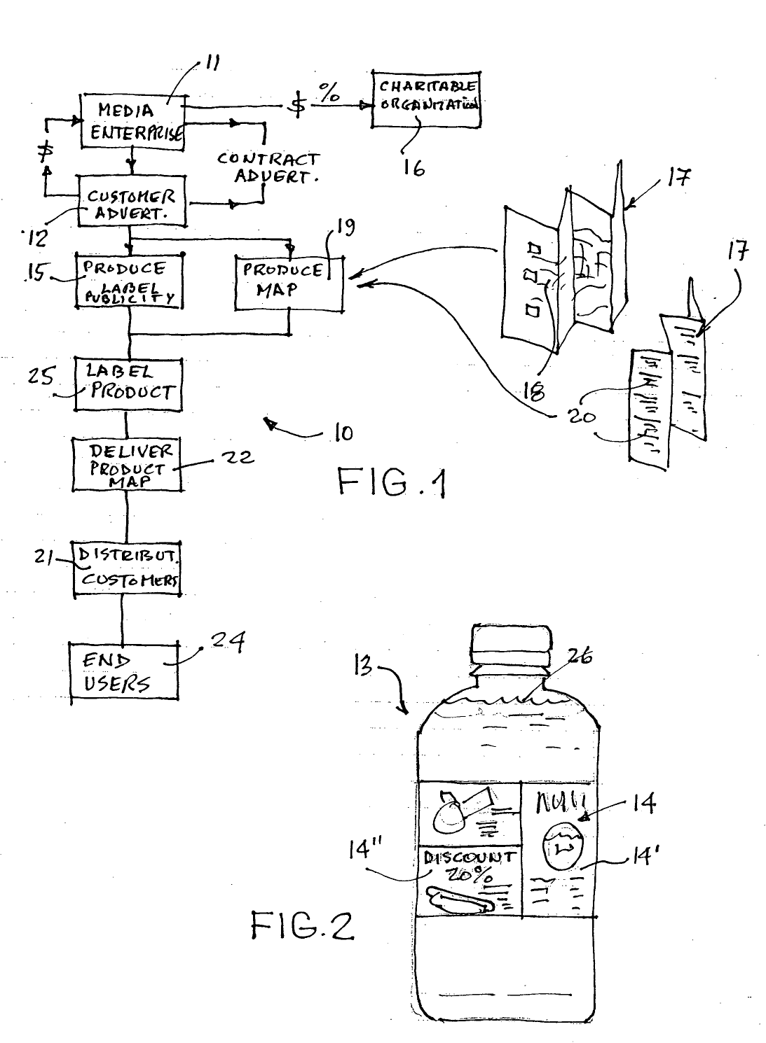

Referring now to the drawings, and more particularly to FIG. 1, there is shown generally at 10 the method of advertising of the present invention. The method comprises essentially the following steps. A media enterprise 11 secures advertising customers 12 which are made aware of the advertising plan of the present invention. The customers are shown a sample of the product 13, as illustrated by step 12 in FIG. 2 as well as the structure of a label 14 to be attached to the product. The customer selects a predetermined segment 14′ of the label and its associated advertising cost and enters into a contractual agreement with the media enterprise. Payment for the selected segment 14′ of the label 14 is made to the media enterprise.

The media enterprise, once he has located advertising customers 12 for all of the segments 14′ of the label 14, then arranges to have the label printed with specific publicity as identified by step 15. The media enterprise 11 also has previously located a charitable organization 16 and effects a payment to the charitable organization based on a percentage of the payments received from its advertising customers. The publicity label is then affixed to the product to be distributed at step 25, herein a water bottle 13 containing spring water 26 therein.

A map 17 of a geographical area 18 is then printed at step 19. The map also contains a listing 20, at a convenient location thereon, of all distribution customers.

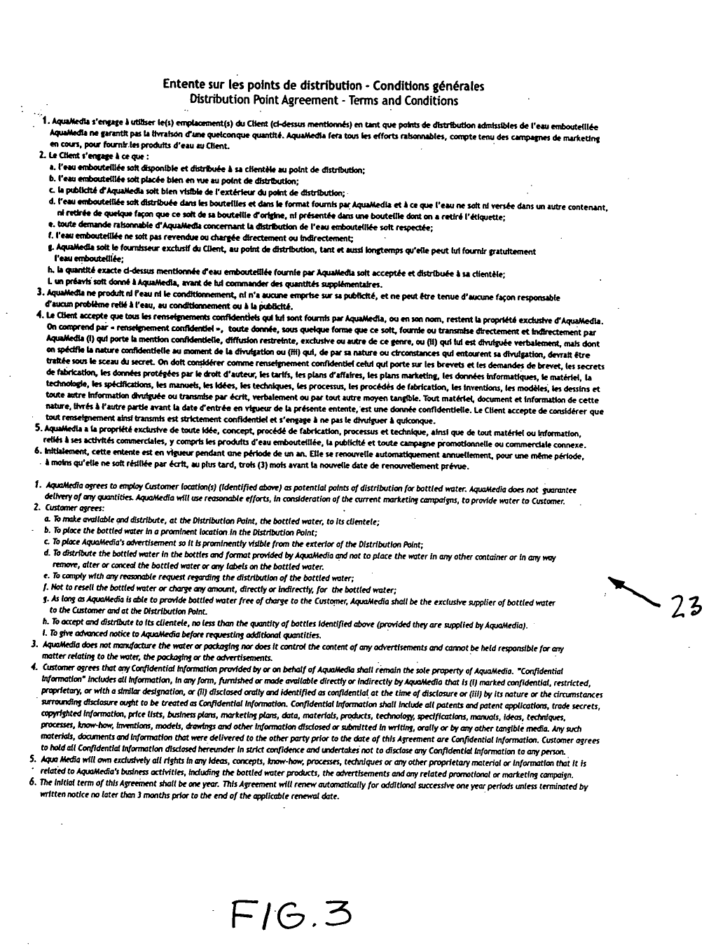

Prior to the printing of this map 17, product distribution customers have been located and have entered in an agreement with the media enterprise 11. These distribution customers are identified at step 21 and they have entered a distribution contract, a portion of which is illustrated in FIG. 3, listing certain specific obligations on their part and also obligations by the media enterprise. The products containing the labels and the map are then delivered at step 22 to the product distribution customers 21 wherein by obligation of the contract 23 of FIG. 3, they agree to certain conditions to ensure the distribution of the products and the maps and to inform the media enterprise of stock requirements. The products and the maps are distributed to end users 24 at no cost, or minimal cost. It is the intent here that end users will go to the product distribution customers whereby to obtain the product at no cost or minimal cost and once in their establishment, they may purchase other goods. Because of the product handouts, the end users will publicize to others and revisit the product distribution customers periodically to obtain the handout products which contain the publicity labels. It is also pointed out that segments of these labels may comprise coupons such as discount coupon 14″ which is removed from the bottle and then utilized to visit the establishment of the advertising customer to obtain the goods at a discounted price.

It is also within the ambit of the present invention to cover obvious modifications of the method of advertising by a media enterprise as described hereinabove. For example, maps can be distributed at distribution points other than the product distribution customers and other publicity media may be used to promote the method of advertising 10, such as newspaper advertisement or television advertisement. The map is also revised on a periodic basis to include the names of new product distribution customers and to remove old ones, if that is the case. Although the product disseminating the publicity is herein illustrated as a water bottle or a soft drink bottle, it can also be a different product capable of containing an advertising label.

1. A method of advertising by a media enterprise comprising the steps of
i) producing a label to be affixed to a product with said label containing advertisement of one or more advertising customers,
ii) affixing said label to a product to be dispensed by distribution customers at no cost or minimal cost,
iii) printing a map of a geographical area including a plurality of said distribution customers to identify them and their location in said geographical area,
iv) delivering said products and said maps in predetermined quantities to said distribution customers, and
v) distributing said products and maps to product end users.

2. A method as claimed in claim 1 wherein there is further provided the step of donating to a charitable organization a percentage of moneys collected from said advertising customers.

3. A method as claimed in claim 1, wherein said product is a bottle containing a drink and wherein said label being affixed about said bottle contains predetermined segments containing advertisement, some of said segments being of different sizes.

4. A method as claimed in claim 1, wherein there is further provided the step of obtaining contractual agreements from distribution customers by said media enterprise to ensure the distribution of said products and maps, and engaging said distribution customer to inform said media enterprise of stock requirements.

5. A label for use with the method of claim 1, said label comprising at least one segment for containing an advertisement, said segment having a predetermined cost value, an advertisement is printed in said segments and associated with a purchaser of said segments.

6. A label as claimed in claim 5 wherein there are two or more segments.

7. A label as claimed in claim 6 wherein said one or more of said segments contain a discount coupon.

8. A label as claimed in claim 6 wherein said label is adhesively secured to a water bottle.

9. A label as claimed in claim 7 wherein said label is removably secured to a water bottle.
